(19) United States
(12) Patent Application Publication
(10) Pub. No.: US 2026/0228612 A1
(43) Pub. Date: Aug. 6, 2026

(54) ANOMALY DETECTION USING PROCESSOR-BASED MACHINE LEARNING MODELS TRAINED USING CROSS-VALIDATION TRAINING DATASETS

(71) Applicant: Dell Products L.P., Round Rock, TX (US)

(72) Inventors: Suhit Datta, Round Rock, TX (US); Anvesh Kalia, Round Rock, TX (US); Prateek Srivastava, Cedar Park, TX (US); Souvik Nath, Howrah (IN); Gopal Chandra Haldar, Bangalore (IN); Sumit Wadhwa, Austin, TX (US)

(21) Appl. No.: 19/046,703

(22) Filed: Feb. 6, 2025

(51) Int. Cl. G06N 20/00

(52) U.S. Cl. CPC G06N 20/00

(57) ABSTRACT

Techniques are provided for anomaly detection using processor-based machine learning (ML) models trained using cross-validation training datasets. One method comprises obtaining data characterizing a plurality of item groupings comprised of one or more items; in response to obtaining additional data corresponding to a given item grouping and associated with a given entity: identifying an ML model selected from a plurality of ML models trained using a cross-validation training process that processes data associated with entities having positive instances of a designated anomalous event, wherein training data for a given entity comprises data associated with positive instances of the designated anomalous event for one or more different entities than the given entity; applying feature values associated with the additional data to the selected ML model to obtain data characterizing an anomaly result; and initiating one or more processing steps based at least in part on the anomaly result.

### BACKGROUND

Anomaly detection generally refers to techniques for identifying patterns or events that deviate from an expected behavior. These techniques can have a variety of applications, including detection of cyberattacks, identification of fraudulent or unauthorized transactions and prediction of equipment failures, as non-limiting examples. Anomaly detection can be an important factor in mitigating potential threats or enabling informed decision-making, for example.

### SUMMARY

Illustrative embodiments of the disclosure provide techniques for anomaly detection using processor-based machine learning (ML) models trained using cross-validation training datasets. One method includes accessing data of a plurality of data structures, wherein each data structure corresponds to a different item grouping of one or more items and comprises a plurality of feature values related to the corresponding item grouping, wherein the plurality of feature values comprises a first feature group comprising one or more first feature values related to an entity associated with the corresponding item grouping and a second feature group comprising one or more second feature values related to the corresponding item grouping, and wherein the entity associated with the corresponding item grouping is one of a plurality of entities associated with the plurality of data structures; in response to obtaining additional data corresponding to a given item grouping of one or more items and being associated with a given entity: identifying a selected ML model, wherein the selected ML model is selected from a plurality of ML models trained using a cross-validation training process that processes data structures associated with entities having positive instances of one or more designated anomalous events, wherein training data for a given entity comprises data from data structures associated with positive instances of the one or more designated anomalous events for one or more different entities than the given entity; applying feature values associated with the additional data corresponding to the given item grouping to the selected ML model to obtain data characterizing an anomaly result; and initiating one or more processing steps based at least in part on the anomaly result.

Illustrative embodiments can provide significant advantages relative to conventional techniques. For example, technical problems related to such conventional techniques are mitigated in one or more embodiments by employing one or more ML models trained using a cross-validation training process that processes training data associated with entities having positive instances of a designated anomalous event and where the training data for a given entity comprises data associated with positive instances of a designated anomalous event for different entities than the given entity.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for anomaly detection using processor-based ML models trained using cross-validation training datasets in accordance with an illustrative embodiment;

FIG. 2 illustrates an exemplary anomalous event detection platform in accordance with an illustrative embodiment;

FIG. 3 illustrates exemplary pseudocode for a logistic regression model development process in accordance with an illustrative embodiment;

FIG. 4 illustrates a training and validation of logistic regression models using cross-validation datasets in accordance with an illustrative embodiment;

FIG. 5 illustrates exemplary pseudocode for a logistic regression model prediction process in accordance with an illustrative embodiment;

FIG. 6 illustrates an exemplary multi-layered implementation of an anomalous event detection platform in accordance with an illustrative embodiment;

FIG. 7 is a flow diagram illustrating an exemplary implementation of a process for anomaly detection using processor-based ML models trained using cross-validation training datasets in accordance with an illustrative embodiment;

FIG. 8 illustrates an exemplary processing platform that may be used to implement at least a portion of one or more embodiments of the disclosure comprising a cloud infrastructure; and

FIG. 9 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for anomaly detection using processor-based ML models trained using cross-validation training datasets.

Rare event detection is a particular type of anomaly detection, where the objective is to detect events with high impact but low probability. As used in this context and elsewhere herein, the term “rare event” is intended to be broadly construed so as to encompass an occurrence of an event with a low probability of happening within a given context, process, or system. A rare event, in some embodiments, is based on whether a frequency of occurrence of an event falls below a configurable threshold within a defined dataset and/or timeframe.

In some embodiments, a gray market transaction can be considered as an example of a rare event. The gray market generally refers to the trade of products via a distribution channel that is unauthorized, unofficial and/or unintended by the original manufacturer and/or distributor. Gray markets often include genuine products that are sold outside of the normal distribution cycle and/or are imported into a market for sale without the consent or knowledge of the original manufacturer or owner. These products are generally sold at lower prices in a particular market than those offered by authorized distribution partners. Authorized price differentials to different markets and customers have created an opportunity for certain enterprises, such as brokers, to purchase branded products in one location at discounted rates and then move them to locations where they can bring greater profits. Gray markets have several negative consequences for the manufacturer and/or distributor of a given product, including decreased revenues, margin erosion, a negative reputation, service issues, warranty issues and/or reduced customer satisfaction.

Detecting rare events is particularly challenging as there is often limited data (e.g., very few positive cases that were classified by experts as being such rare events) and such events may not necessarily deviate significantly from normal behavior. For example, conventional techniques generally rely on ML models that treat rare events as a binary classification problem where the classification of whether or not an event is a rare event is performed when the event is occurring. However, this approach has several disadvantages.

Using gray markets as an example, there are often large quantities of transactions (e.g., millions or more) that are occurring. In order to generate training data, an investigation is typically performed to determine whether a given one of the transactions is a gray market transaction or not.

In the context of gray markets, for example, some embodiments can identify market entities prior to a transaction being converted into an order (e.g., when a customer reaches out to a sales team) using a ML model. Instead of learning a decision boundary separating anomalous and non-anomalous data points, some embodiments can identify similarities with respect to confirmed gray market transactions. In at least one embodiment, gray market transactions in a dataset are treated as anomalous data points (e.g., positive instances of an anomalous event), and the remaining transactions in the dataset are treated as non-anomalous data points (e.g., negative instances of the anomalous event), as described in more detail elsewhere herein.

A dataset pertaining to gray market and other fraudulent transactions, for example, may encompass details such as pricing data, product details and/or characteristics associated with users, businesses and/or organizations involved in such transactions. In some embodiments the data is assumed to be in a tabular format. It is to be appreciated that different types and number of features can be used based on the context.

One or more aspects of the disclosure recognize that a suspiciously low price of products associated with a given quote, for example, can be a good identifier of a gray market seller. A minimum advertised price of a given product may be monitored across sellers (e.g., across all distribution channels) to highlight violators and unauthorized sellers, providing improved insight into a gray market or other fraudulent transactions. For example, a repurchase program may be employed to purchase one or more products sold by unauthorized sellers at low prices and then to trace back such repurchased products to further analyze an account and an order associated with an original purchase of the repurchased products.

Embodiments described herein identify suspected gray market transactions (and other fraudulent transactions) using at least one ML model trained using training data comprising confirmed gray market transactions. For example, supervised learning techniques may be employed using transactions labeled as fraudulent transactions and/or high-risk transactions. The at least one trained ML mode identifies suspicious gray market transactions that are similar to confirmed gray market transactions in the training data (e.g., prior to a given suspicious gray market transaction being converted into an order). In some embodiments, the at least one ML model may also provide one or more quote adjustment recommendations for a given transaction (e.g., to modify a price associated with the given transaction and/or improve a margin associated with the given transaction).

As noted above, one issue with industry fraud data is that there are often very few positive cases that were classified by experts as being fraudulent. Autoencoders (e.g., neural networks) may be used to learn a distribution of negative cases (where the neural network is trained to reconstruct input data on an output of negative cases), and then a reconstruction error of the autoencoder is observed. When the reconstruction error is higher, an input sample is considered to be a positive case because the autoencoder does not know how to reconstruct the corresponding output (e.g., the input same is different from the training data of negative cases).

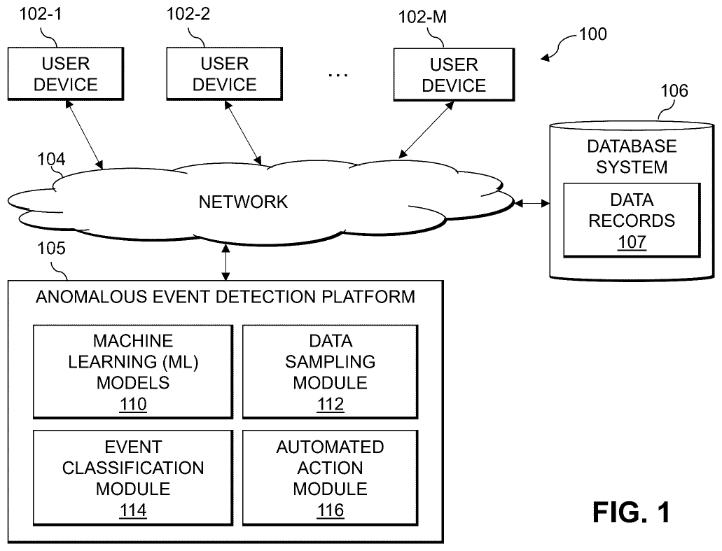

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an anomalous event detection platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

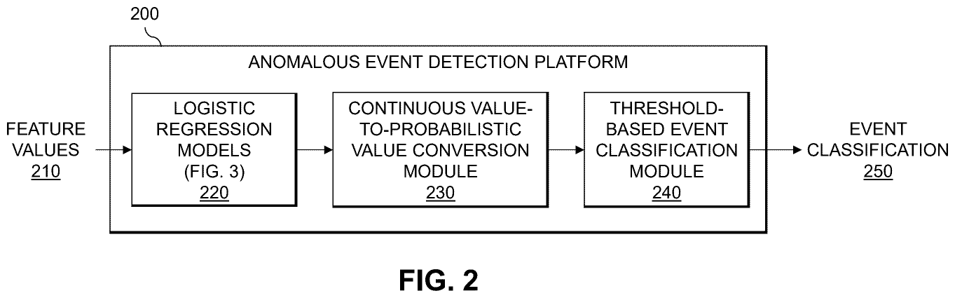

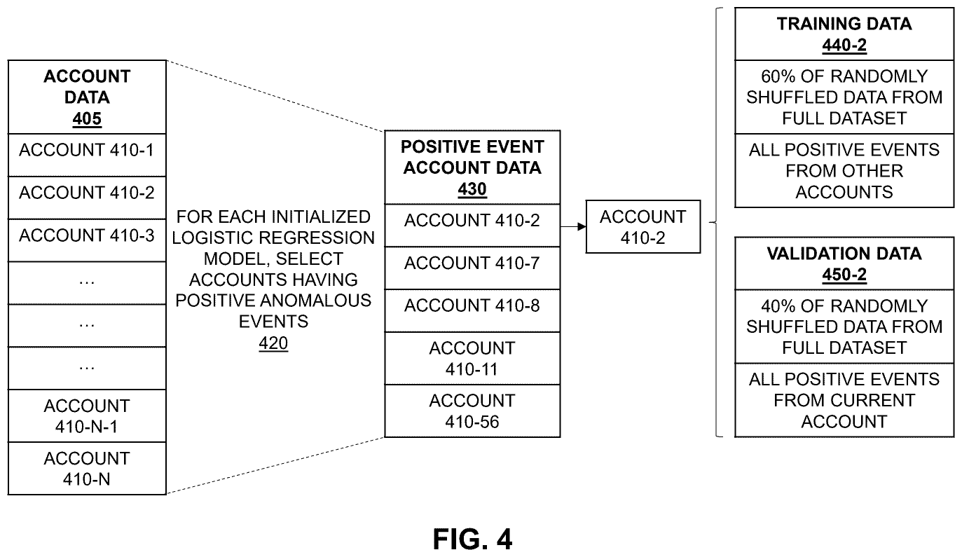

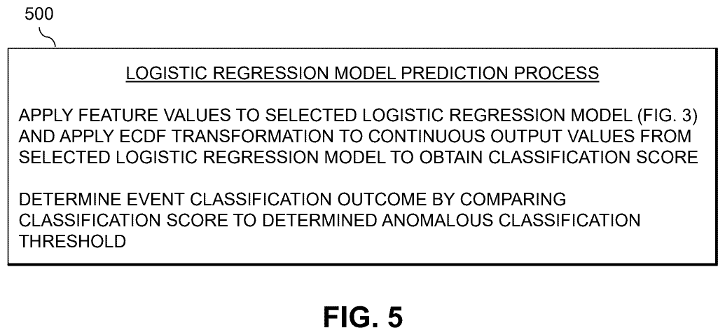

The anomalous event detection platform 105 may comprise one or more ML models 110, a data sampling module 112, an event classification module 114 and an automated action module 116. The ML models 110, in some embodiments, may perform anomaly detection in accordance with the disclosed techniques, as discussed further below in conjunction with FIG. 5, for example. The ML models 110 may be implemented, for example, as logistic regression models, as discussed further below in conjunction with FIG. 2. In at least some embodiments, the data sampling module 112 may generate training and/or validation data using the disclosed cross-validation datasets, as discussed further below in conjunction with FIG. 4, for example.

In one or more embodiments, the event classification module 114 may determine an event classification outcome by comparing a classification score generated by one or more of the ML models 110 to determined anomalous classification thresholds, as discussed further below in conjunction with FIG. 5, for example. The automated action module 116 may perform one or more automated actions (e.g., processing steps) based at least in part on an anomaly result, such as generating a notification related to the anomaly result, automatically denying the given item grouping based at least in part on the anomaly result, automatically modifying the given item grouping based at least in part on the anomaly result, providing one or more recommendations to adjust at least one parameter of the given item grouping and causing an action to be performed in another system based at least in part on the anomaly result.

It is to be appreciated that this particular arrangement of elements 110, 112, 114 and/or 116 illustrated in the anomalous event detection platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

Additionally, the database system 106 may comprise one or more databases, such as data records 107 (e.g., comprising information associated with positive and negative instances of a designated anomalous event for different entities). The data records 107 may be configured to store data, for example, in tables, in a known manner. While the database system 106 is illustrated in FIG. 1 as a single database, at least portions of the database system 106 may be implemented as multiple distinct databases. Example database system 106, such as depicted in the present embodiment, can be implemented using one or more storage systems associated with the anomalous event detection platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the anomalous event detection platform 105 are one or more input-output devices, which illustratively comprise keyboards, displays or other types of input-output devices in any combination. Such input-output devices can be used, for example, to support one or more user interfaces to the anomalous event detection platform 105, as well as to support communication between anomalous event detection platform 105 and other related systems and devices not explicitly shown.

Additionally, the anomalous event detection platform 105 in the FIG. 1 embodiment is assumed to be implemented using at least one processing device. Each such processing device generally comprises at least one processor and an associated memory, and implements one or more functional modules for controlling certain features of the anomalous event detection platform 105. More particularly, the anomalous event detection platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the anomalous event detection platform 105 to communicate over the network 104 with the user devices 102, and illustratively comprises one or more conventional transceivers.

It is to be understood that the particular set of elements shown in FIG. 1 for the anomalous event detection platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the anomalous event detection platform 105 and at least portions of the database system 106 can be on and/or part of the same processing platform.

FIG. 2 illustrates an exemplary anomalous event detection platform 200 in accordance with an illustrative embodiment. In the example of FIG. 2, one or more feature values 210 are applied to the anomalous event detection platform 200. The particular feature values 210 that are considered may be selected, for example, in a feature engineering stage. In one or more embodiments, two classes of features may be employed. For example, (i) quote-based features may comprise a creation date of a quote (e.g., an item grouping), a number of products of a given class (e.g., software and/or peripheral devices) in the quote, a revenue associated with the quote, a revenue after a provided discount; and (ii) account-based features may comprise an account creation date, a number of orders associated with the account (e.g., an entity associated with a particular item grouping) in a previous quarter, and a partner account identifier. Raw data may be used to compute specific features. Exemplary features may comprise a creation date, a number of software and peripherals in a quote, a revenue associated with the quote, a revenue after discount, a difference between a creation date of an account and a date of a given quote and/or a ratio of order revenue in a current quarter to the previous 12 quarters, for example.

A variety of engineered features may be employed that encapsulate key aspects of the data. The employed features may be categorized into thematic groups, for example, based on their functionality and the domain insights provided by such features. In at least some embodiments, one or more of the following feature types may be employed:
1. proportional metrics that compare quantities and/or values to provide insights into proportional relationships;
2. temporal comparisons of metrics derived over specific time periods, often capturing trends and/or historical behavior, for example;
3. difference metrics that measure absolute differences between related variables;
4. customer behavioral metrics that reflect customer-related insights, such as order patterns, preferences and demographics;
5. sales and revenue metrics associated with sales performance and billing details;
6. partner and vendor-specific metrics that capture partner and/or vendor-level interactions and performance;
7. statistical aggregates that summarize key statistical properties, such as averages and variances;
8. product-specific metrics related to specific products and/or product categories;
9. account-level metrics at the account level that aggregate and/or summarize performance indicators; and
10. miscellaneous features that may be unique features and/or outlier features that provide additional context and/or handle edge cases.

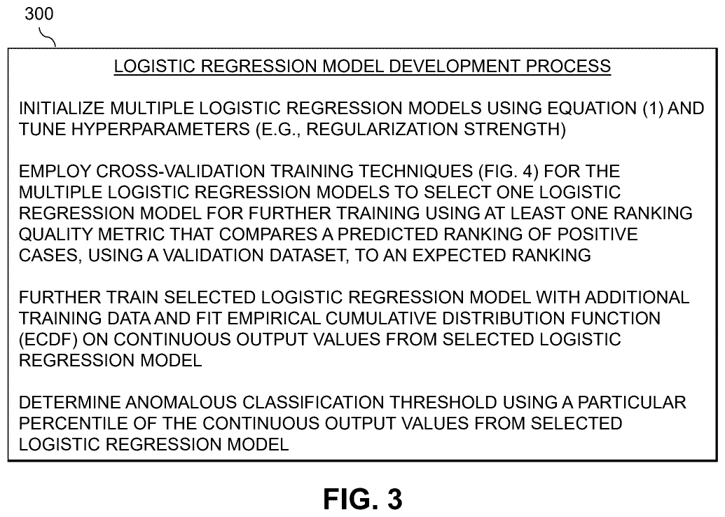

The exemplary anomalous event detection platform 200 comprises one or more logistic regression models 220, as discussed further below in conjunction with FIG. 3, that generate continuous output values. A training and validation of the one or more logistic regression models 220 is discussed further below in conjunction with FIGS. 3 and 4.

A continuous value-to-probabilistic value conversion module 230 is employed in some embodiments to convert the continuous values generated by the one or more logistic regression models 220 to probabilistic values. The continuous value-to-probabilistic value conversion module 230 may employ, for example, an empirical cumulative distribution function (ECDF) to perform the continuous value-to-probabilistic value conversion.

A threshold-based event classification module 240 applies one or more thresholds to the probabilistic value generated by the continuous value-to-probabilistic value conversion module 230 to determine an event classification 250 (e.g., an anomaly result), as discussed further below in conjunction with FIG. 5.

The logistic regression models 220 are employed in some embodiments, as they provide explainable results. Among other benefits, explainability allows specific remediation actions to be suggested. The term “explainability” as used herein refers to the notion that some ML algorithms produce models whose decisions may be explained to someone with less expertise in the field. If an ML model produces an explainable result, the result will generally be deemed more trustworthy.

In at least some embodiments, each logistic regression model 220 may be expressed as follows:

$$y = {b}_{1} {x}_{1} + {b}_{2} {x}_{2} + … + {b}_{n} {x}_{n} , \qquad ( 1 )$$

where b₁ through bₙ are coefficient values and x₁ through xₙ comprise different feature values 210. Equation (1) is sometimes referred to as a decision function of the logistic regression model 220. In this manner, the logistic regression models 220 capture the underlying relationships between the feature values 210 and the output of the logistic regression models 220.

In at least some embodiments, the continuous values determined using equation (1) may be converted to corresponding probabilistic values using equation (2):

$$F ( x ) = \frac{1}{( 1 + {e}^{- y} )} . \qquad ( 2 )$$

where x and y are defined in the same manner as equation (1).

FIG. 3 illustrates exemplary pseudocode for a logistic regression model development process 300 in accordance with an illustrative embodiment. In the example of FIG. 3, multiple logistic regression models are initialized using equation (1) and one or more hyperparameters (e.g., regularization strength). The initialized logistic regression models are trained using a cross-validation data split (e.g., because of the small population of positive (ground truth) cases during training). A cross-validation data split may be created in at least some embodiments for each account where positive cases of gray market transactions and/or other fraudulent transactions were identified.

During a model evaluation phase, a score is assigned to each sample in a validation set and the samples are ranked using the assigned scores. A normalized discounted cumulative gain (NDCG) metric, for example, or another ranking quality metric, may be used to evaluate a ranking quality of the current logistic regression model by comparing how well a predicted ranking of positive cases matches an expected (e.g., ideal) ranking. The NDCG metric evaluates ranking quality by taking into account a position of a relevant item and its importance or relevance. In this manner, the model effectively prioritizes positive and/or confirmed cases of a given designated anomalous event.

Each logistic regression model is trained and scored for each split, and the best model is selected (e.g., the initialized logistic regression model object with the highest NDCG value may be selected for further training). The selected logistic regression model is further trained using additional training data and an empirical cumulative distribution function (ECDF) is fit on the continuous output values from the selected logistic regression model.

An anomalous classification threshold is determined using, for example, a particular percentile (e.g., 99.7 percentile) of the continuous output values from the selected logistic regression model. For example, an ECDF may be fit on all training scores (calculated using equation (1) and standardized in the range 0-1) and the threshold value may be set to 0.997 (99.7 percentile of all training scores). Generally, an ECDF transforms the distribution of output values of a function in such a way that the fraction of items with values below a certain level in the ECDF is that level: that is, if E is the ECDF associated with a model function ƒ, then 10% of all inputs will be such that E(ƒ(x))<0.1, 20% will be such that E(ƒ(x))<0.2, etc.

In one or more embodiments, different sets of logistic regression models may be separately trained and maintained for different regions (e.g., the Americas, Europe, the Middle East and Africa (EMEA) and Asia Pacific (APJ)).

FIG. 4 illustrates a training and validation of logistic regression models using cross-validation datasets in accordance with an illustrative embodiment. In the example of FIG. 4, account data 405, for example, associated with all accounts 410-1 through 410-N of a given organization, is processed to select accounts having positive anomalous events during step 420 for each initialized logistic regression model. Step 420 may generate positive event account data 430 for those accounts having positive anomalous events. The example of FIG. 4 assumes that the following accounts have positive anomalous events: account 410-2, account 410-7, account 410-8, account 410-11 and account 410-56.

Consider representative account 410-2 that is one of the accounts having positive anomalous events. As shown in FIG. 4, the account data for account 410-2 is processed to generate training data 440-2 and validation data 450-2. The training data 440-2 for account 410-2 is comprised of, for example, 60% of randomly shuffled data from the account data 405 dataset (e.g., from all accounts 410, whether or not they encountered positive anomalous events) and all positive events from accounts other than the current account 410-2.

The validation data 450-2 for account 410-2 is comprised of, for example, 40% of randomly shuffled data from the account data 405 dataset and all positive events from the current account 410-2.

Thus, in some embodiments, a K-fold cross-validation technique may be employed to evaluate the performance of at least one ML model (e.g., a logistic regression model). K-fold cross-validation divides the input dataset into k subsets or folds of approximately equal size. In the example of FIG. 4, each fold in the data can be partitioned randomly in a ratio of approximately 60:40, with 60% of the data fold used for training the at least one ML model, along with positive cases (e.g., positive gray market transactions or other fraudulent transactions) that are not associated with the current account (with the assumption that the occurrence of the designated anomalous events will be consistent across accounts). The remaining 40% of the data can then be used for validating the at least one ML model, along with positive cases (e.g., positive gray market transactions or other fraudulent transactions) that are associated with the current account.

The same training data 440-2 and validation data 450-2 may be employed for multiple models. For example, three logistic regression models may be separately trained using the same training data 440-2 and validation data 450-2, with the positive cases in the training data 440-2 and validation data 450-2 coming from accounts 410-2, 410-7, 410-8, 410-11 and 410-56 having positive cases.

FIG. 5 illustrates exemplary pseudocode for a logistic regression model prediction process 500 in accordance with an illustrative embodiment. In the example of FIG. 5, at runtime, for example, feature values (e.g., associated with a given item grouping or order) are applied to the selected logistic regression model, as discussed above in conjunction with FIG. 3, and an ECDF transformation is applied to the continuous output values generated by the selected logistic regression model to obtain a classification score.

An event classification outcome is determined by comparing the obtained classification score to a previously determined anomalous classification threshold. Thus, during the prediction phase, an ECDF transformation may be applied to an output (e.g., a score) of the selected logistic regression model. If the transformed score is higher than the designated threshold (e.g., higher than the 99.7 percentile of all training scores), the transaction is classified as positive (e.g., a suspected gray market transaction or other fraudulent transaction).

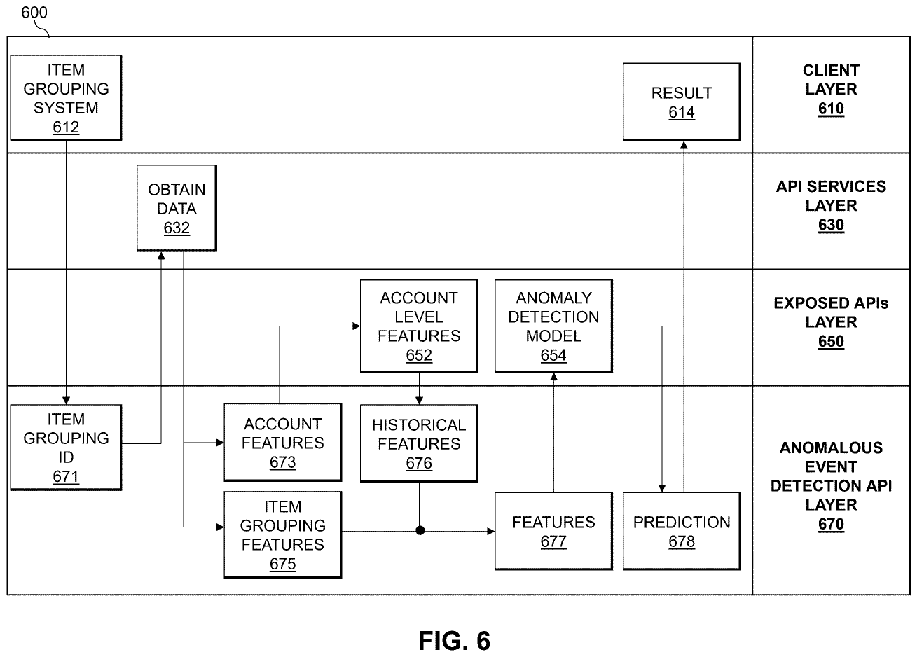

FIG. 6 illustrates an exemplary multi-layered implementation of an anomalous event detection platform 600 in accordance with an illustrative embodiment. In the example of FIG. 6, an item grouping system 612, in a client layer 610, generates one or more item groups (e.g., quotes). An item grouping identifier 671, in an anomalous event detection API layer 670, provides item grouping information to an application programming interface (API) services layer 630, in response to an obtain data request 632, so that the item grouping can be evaluated (e.g., in real-time) to determine if the item grouping is associated with a gray market transaction or another fraudulent transaction.

One or more item grouping-based features 675 and account-based features 673, as described above, in the anomalous event layer 670, are evaluated by the anomaly detection platform. One or more of the account-based features 673 may be further processed, for example, in an exposed API layer 650, to access account-level features 652 that are incorporated into historical features 677, in the anomalous event layer 670.

A set of features 677, based at least in part on the item grouping-based features 675 and the historical features 677, is applied to an anomaly detection model 654, in the exposed API layer 650, such as a gray market detection model, for example, using a storage API, to generate a prediction 678. An anomaly detection result 614 may be provided to a client, in the client layer 610, based at least in part on the generated prediction 678. As noted above, an ECDF transformation may be applied to the output (e.g., a score) of the anomaly detection model 654. If the transformed score is higher than the threshold (e.g., higher than the 99.7 percentile of all training scores), the transaction is classified as positive (e.g., a suspected gray market transaction or other fraudulent transaction).

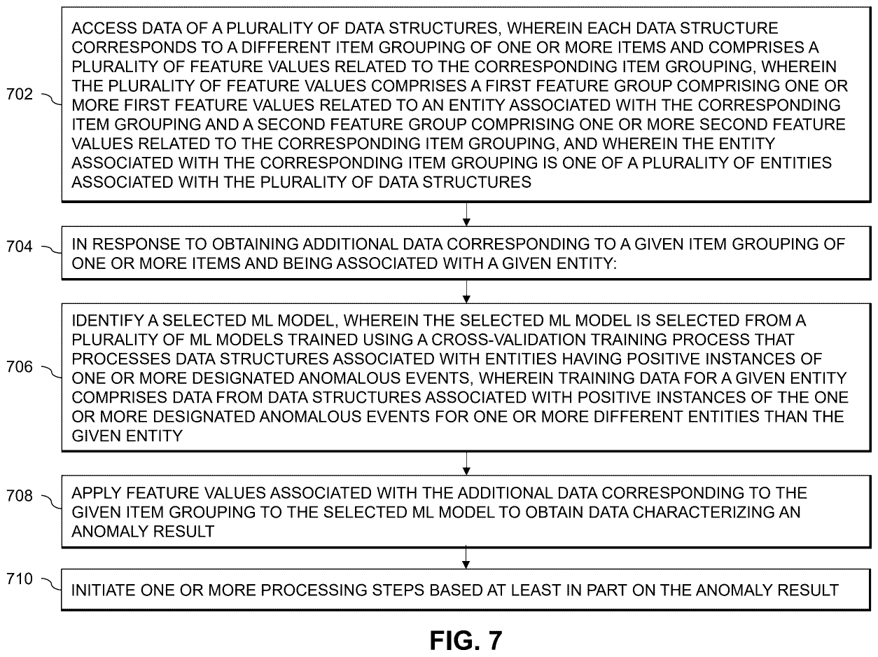

FIG. 7 is a flow diagram illustrating an exemplary implementation of a process for anomaly detection using processor-based ML models trained using cross-validation training datasets in accordance with an illustrative embodiment. In the example of FIG. 7, data of a plurality of data structures is accessed in step 702, wherein each data structure corresponds to a different item grouping of one or more items and comprises a plurality of feature values related to the corresponding item grouping, wherein the plurality of feature values comprises a first feature group comprising one or more first feature values related to an entity associated with the corresponding item grouping and a second feature group comprising one or more second feature values related to the corresponding item grouping, and wherein the entity associated with the corresponding item grouping is one of a plurality of entities associated with the plurality of data structures.

In response to obtaining, in step 704, additional data corresponding to a given item grouping of one or more items and being associated with a given entity, steps of 706 through 710 are performed.

In step 706, a selected ML model is identified, wherein the selected ML model is selected from a plurality of ML models trained using a cross-validation training process that processes data structures associated with entities having positive instances of one or more designated anomalous events, wherein training data for a given entity comprises data from data structures associated with positive instances of the one or more designated anomalous events for one or more different entities than the given entity.

Feature values associated with the additional data corresponding to the given item grouping is applied to the selected ML model in step 708 to obtain data characterizing an anomaly result. One or more processing steps are initiated in step 710 based at least in part on the anomaly result.

In at least one embodiment, the selected ML model assigns at least a first weight to a first feature and a second weight to a second feature. Each different item grouping may correspond to an order quote for the one or more items.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example.

In one or more embodiments, the anomaly result is obtained by mapping a continuous value generated by the selected ML model to a probabilistic value and applying a threshold to the probabilistic value. The threshold may be determined by training the selected ML model with additional training data and fitting an empirical cumulative distribution function to output values generated by the selected ML model.

In some embodiments, the cross-validation training process further processes validation data for the given entity comprising data structures associated with positive instances of the one or more designated anomalous events for the given entity. The one or more designated anomalous events may comprise one or more of a gray market transaction, a fraudulent transaction and an anomalous number of accounts ending a relationship with the given entity in a designated time period. The one or more processing steps may comprise at least one of: generating a notification related to the anomaly result, automatically denying the given item grouping based at least in part on the anomaly result, automatically modifying the given item grouping based at least in part on the anomaly result and causing an action to be performed in another system based at least in part on the anomaly result.

The particular processing operations and other network functionality described in conjunction with FIGS. 2 through 5 and 7, for example, are presented by way of illustrative example only, and should not be construed as limiting the scope of the disclosure in any way. Alternative embodiments can use other types of processing operations for anomaly detection using processor-based ML models trained using cross-validation training datasets. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for anomaly detection using processor-based ML models trained using cross-validation training datasets. The foregoing applications and associated embodiments should be considered as illustrative only, and numerous other embodiments can be configured using the techniques disclosed herein, in a wide variety of different applications.

It should also be understood that the disclosed techniques for anomaly detection using processor-based ML models trained using cross-validation training datasets, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for anomaly detection using processor-based ML models trained using cross-validation training datasets may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based anomaly detection engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based anomaly detection platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

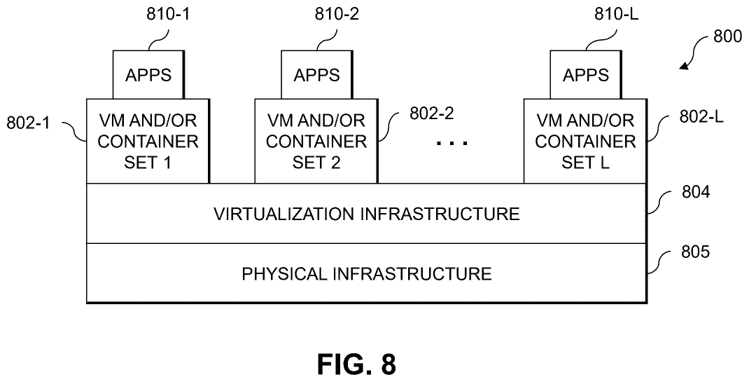

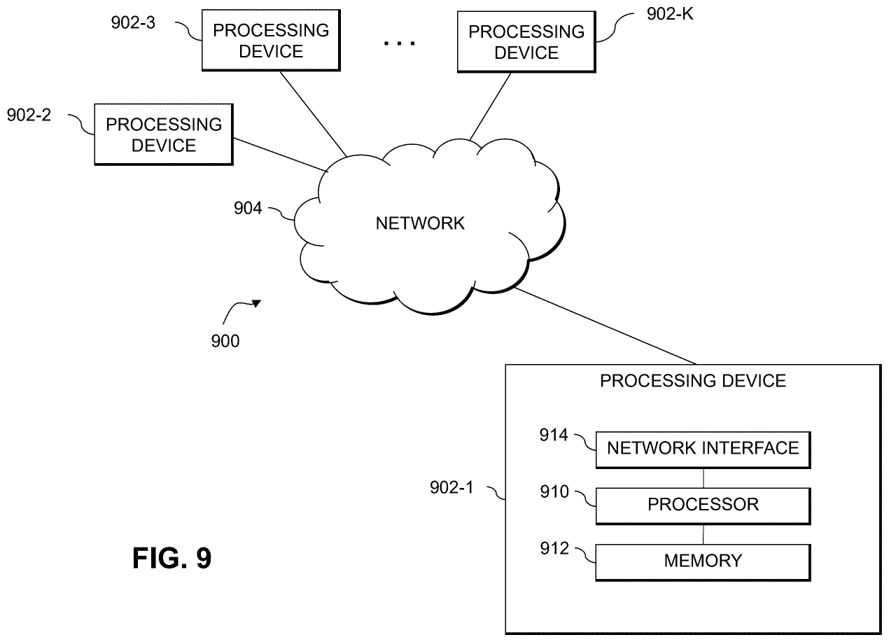

Illustrative embodiments of processing platforms will now be described in greater detail with reference to FIGS. 8 and 9. These platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. Such implementations can provide anomaly detection functionality of the type described above for one or more processes running on a given one of the VMs. For example, each of the VMs can implement control logic for anomaly detection and associated functionality for training ML models using cross-validation techniques.

An example of a hypervisor platform that may be used to implement a hypervisor within the virtualization infrastructure 804 is a compute virtualization platform which may have an associated virtual infrastructure management system such as server management software. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system. Such implementations can provide anomaly detection functionality of the type described above for one or more processes running on different ones of the containers. For example, a container host device supporting multiple containers of one or more container sets can implement one or more instances of control logic for anomaly detection and associated functionality for training ML models using cross-validation techniques.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises at least a portion of the given system and includes a plurality of processing devices, denoted 902-1, 902-2, 902-3, . . . 902-K, which communicate with one another over a network 904. The network 904 may comprise any type of network, such as a WAN, a LAN, a satellite network, a telephone or cable network, a cellular network, a wireless network such as WiFi or WiMAX, or various portions or combinations of these and other types of networks.

The processing device 902-1 in the processing platform 900 comprises a processor 910 coupled to a memory 912. The processor 910 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 912, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 8 or 9, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
accessing data of a plurality of data structures, wherein each data structure corresponds to a different item grouping of one or more items and comprises a plurality of feature values related to the corresponding item grouping, wherein the plurality of feature values comprises a first feature group comprising one or more first feature values related to an entity associated with the corresponding item grouping and a second feature group comprising one or more second feature values related to the corresponding item grouping, and wherein the entity associated with the corresponding item grouping is one of a plurality of entities associated with the plurality of data structures;
in response to obtaining additional data corresponding to a given item grouping of one or more items and being associated with a given entity:
identifying a selected machine learning (ML) model, wherein the selected ML model is selected from a plurality of ML models trained using a cross-validation training process that processes data structures associated with entities having positive instances of one or more designated anomalous events, wherein training data for a given entity comprises data from data structures associated with positive instances of the one or more designated anomalous events for one or more different entities than the given entity;
applying feature values associated with the additional data corresponding to the given item grouping to the selected ML model to obtain data characterizing an anomaly result; and
initiating one or more processing steps based at least in part on the anomaly result;
wherein the method is performed by at least one processing device comprising a processor coupled to a memory.

2. The method of claim 1, wherein the selected ML model comprises a regression model that assigns at least a first weight to a first feature and a second weight to a second feature.

3. The method of claim 1, wherein each different item grouping corresponds to an order quote for the one or more items.

4. The method of claim 1, wherein the anomaly result is obtained by mapping a continuous value generated by the selected ML model to a probabilistic value and applying a threshold to the probabilistic value.

5. The method of claim 4, wherein the threshold is determined by training the selected ML model with additional training data and fitting an empirical cumulative distribution function to output values generated by the selected ML model.

6. The method of claim 1, wherein the cross-validation training process further processes validation data for the given entity comprising data structures associated with positive instances of the one or more designated anomalous events for the given entity.

7. The method of claim 1, wherein the one or more designated anomalous events comprise one or more of a gray market transaction, a fraudulent transaction and an anomalous number of accounts ending a relationship with the given entity in a designated time period.

8. The method of claim 1, wherein the one or more processing steps comprise at least one of: generating a notification related to the anomaly result, automatically denying the given item grouping based at least in part on the anomaly result, automatically modifying the given item grouping based at least in part on the anomaly result, providing one or more recommendations to adjust at least one parameter of the given item grouping and causing an action to be performed in another system based at least in part on the anomaly result.

9. An apparatus comprising:
at least one processing device comprising a processor coupled to a memory;
the at least one processing device being configured to implement the following steps:
accessing data of a plurality of data structures, wherein each data structure corresponds to a different item grouping of one or more items and comprises a plurality of feature values related to the corresponding item grouping, wherein the plurality of feature values comprises a first feature group comprising one or more first feature values related to an entity associated with the corresponding item grouping and a second feature group comprising one or more second feature values related to the corresponding item grouping, and wherein the entity associated with the corresponding item grouping is one of a plurality of entities associated with the plurality of data structures;
in response to obtaining additional data corresponding to a given item grouping of one or more items and being associated with a given entity:
identifying a selected machine learning (ML) model, wherein the selected ML model is selected from a plurality of ML models trained using a cross-validation training process that processes data structures associated with entities having positive instances of one or more designated anomalous events, wherein training data for a given entity comprises data from data structures associated with positive instances of the one or more designated anomalous events for one or more different entities than the given entity;
applying feature associated with the additional data corresponding to the given item grouping to the selected ML model to obtain data characterizing an anomaly result; and
initiating one or more processing steps based at least in part on the anomaly result.

10. The apparatus of claim 9, wherein the selected ML model comprises a regression model that assigns at least a first weight to a first feature and a second weight to a second feature.

11. The apparatus of claim 9, wherein each different item grouping corresponds to an order quote for the one or more items.

12. The apparatus of claim 9, wherein the anomaly result is obtained by mapping a continuous value generated by the selected ML model to a probabilistic value and applying a threshold to the probabilistic value, wherein the threshold is determined by training the selected ML model with additional training data and fitting an empirical cumulative distribution function to output values generated by the selected ML model.

13. The apparatus of claim 9, wherein the cross-validation training process further processes validation data for the given entity comprising data structures associated with positive instances of the one or more designated anomalous events for the given entity.

14. The apparatus of claim 9, wherein the one or more designated anomalous events comprise one or more of a gray market transaction, a fraudulent transaction and an anomalous number of accounts ending a relationship with the given entity in a designated time period.

15. A non-transitory processor-readable storage medium having stored therein program code of one or more software programs, wherein the program code when executed by at least one processing device causes the at least one processing device to perform the following steps:
accessing data of a plurality of data structures, wherein each data structure corresponds to a different item grouping of one or more items and comprises a plurality of feature values related to the corresponding item grouping, wherein the plurality of feature values comprises a first feature group comprising one or more first feature values related to an entity associated with the corresponding item grouping and a second feature group comprising one or more second feature values related to the corresponding item grouping, and wherein the entity associated with the corresponding item grouping is one of a plurality of entities associated with the plurality of data structures;
in response to obtaining additional data corresponding to a given item grouping of one or more items and being associated with a given entity;
identifying a selected machine learning (ML) model, wherein the selected ML model is selected from a plurality of ML models trained using a cross-validation training process that processes data structures associated with entities having positive instances of one or more designated anomalous events, wherein training data for a given entity comprises data from data structures associated with positive instances of the one or more designated anomalous events for one or more different entities than the given entity;
applying feature values associated with the additional data corresponding to the given item grouping to the selected ML model to obtain data characterizing an anomaly result; and
initiating one or more processing steps based at least in part on the anomaly result.

16. The non-transitory processor-readable storage medium of claim 15, wherein the selected ML model comprises a regression model that assigns at least a first weight to a first feature and a second weight to a second feature.

17. The non-transitory processor-readable storage medium of claim 15, wherein each different item grouping corresponds to an order quote for the one or more items.

18. The non-transitory processor-readable storage medium of claim 15, wherein the anomaly result is obtained by mapping a continuous value generated by the selected ML model to a probabilistic value and applying a threshold to the probabilistic value, wherein the threshold is determined by training the selected ML model with additional training data and fitting an empirical cumulative distribution function to output values generated by the selected ML model.

19. The non-transitory processor-readable storage medium of claim 15, wherein the cross-validation training process further processes validation data for the given entity comprising data structures associated with positive instances of the one or more designated anomalous events for the given entity.

20. The non-transitory processor-readable storage medium of claim 15, wherein the one or more designated anomalous events comprise one or more of a gray market transaction, a fraudulent transaction and an anomalous number of accounts ending a relationship with the given entity in a designated time period.
